(19) United States
(12) Patent Application Publication
(10) Pub. No.: US 2010/0058739 A1
(43) Pub. Date: Mar. 11, 2010

(54) EXHAUST EMISSION PURIFICATION CATALYST AND ENGINE CONTROLLER

(76) Inventor: Kinichi IWACHIDO, Aichi-gun (JP)

Correspondence Address: BIRCH STEWART KOLASCH & BIRCH, PO BOX 747, FALLS CHURCH, VA, 22040-0747, US

(21) Appl. No.: 12/555,565

(22) Filed: Sep. 8, 2009

(30) Foreign Application Priority Data
Sep. 9, 2008 (JP) P2008-230902

(51) Int. Cl. F01N 3/00; F01N 3/10; B01J 29/04

(52) U.S. Cl. 60/285; 60/299; 502/74; 502/60

(57) ABSTRACT

An exhaust emission purification catalyst which purifies exhaust gas of an engine, includes: a carrier which is formed with a plurality of cell holes; and a plurality of catalytic layers which are carried in the plurality of cell holes. The plurality of catalytic layers includes: a first layer including an auxiliary catalyst that includes a zeolite including a transition metal that occludes NOx in the exhaust gas during a time period of low temperature; and a second layer disposed adjacent to a surface of the first layer and including a main catalyst that includes at least one of an alkali metal and an alkali earth metal and that occludes the NOx occluded in the auxiliary catalyst when temperature of the main catalyst reaches active temperature.

### BACKGROUND OF THE INVENTION

The present invention relates to an exhaust emission purification catalyst which purifies exhaust gas of an engine and an engine controller which controls an engine including the exhaust emission purification catalyst in a position along the length of an exhaust path of a motor vehicle.

In gasoline engines and diesel engines, exhaust emission purification during a time of low temperatures (this being referred to as a cold phase) that continues until the catalyst reaches its active temperature has constituted a big issue.

As to purification of HC (hydrocarbons) in such a cold phase, for example, JP-A-2003-343316 discloses an HC trapping catalyst which temporarily traps (absorbs) HC discharged from an engine when the engine and a catalyst are both at low temperatures as immediately after the engine has been started and thereafter desorbs the trapped HC for purification as the engine and the catalyst get warmed.

On the other hand, Japanese Patent No. 3482661, for example, discloses a technique for removing oxides of nitrogen by causing a catalyst in which at least one or more types of transition metal are made to be contained in a zeolite having an MFS construction, to be brought into contact with exhaust gases, which are in excess of oxygen, containing oxides of nitrogen and hydrocarbons.

Further, as to purification of NOx (oxides of nitrogen) in the cold phase, JP-A-5-317649 discloses a technique for purifying oxides of nitrogen in exhaust gases by causing exhaust gases which are in excess of oxygen, to be brought into contact with an iron zeolite catalyst which includes a zeolite and iron element which is ion exchanged for aluminum element in a zeolite in amount of 0.05 to 0.3 by molar ratio and is carried.

Incidentally, in order for HC to be reduced largely in the cold phase without using the HC trapping catalyst, it is effective to shorten the time period of the cold phase by realizing a quick rise in the catalyst's temperature while suppressing the generation of HC. To make this happen, there are approaches of retardation of ignition timing and increasing the engine speed by increasing the output torque of the engine after the air-fuel (A/F) ratio has been controlled to be leaner than the stoichiometric air-fuel ratio. The generation of HC can be suppressed by the air-fuel ratio being made lean, and the quick rise in the catalyst's temperature can be realized by retarding the ignition timing and increasing the engine speed.

When these controls are carried out, however, the supply of a certain amount of fuel needs to be ensured to meet the increase in output torque of the engine, and in addition to this, since the air-fuel ratio is made lean, a large increase in the amount of intake air is called for. Since a large increase in the amount of intake air calls for a large increase in the amount of NOx generated, the purification of NOx that is so increased becomes a large issue.

In this respect, the techniques for trapping generated NOx even during the time period of low temperatures by application of the zeolite catalyst containing the transition metal which are disclosed by Japanese Patent No. 3482661 and JP-A-5-317649 become effective in purification of NOx. In this case, however, how to purify NOx which is trapped by and are then desorbed (purged) from the zeolite catalyst becomes an issue to be solved.

### SUMMARY

It is therefore an object of the invention to provide an exhaust emission purification catalyst and an engine controller which enable the suppression of discharge of HC and NOx in a cold phase (a low-temperature time period until the catalyst reaches its active temperature) without using the HC trapping catalyst.

In order to achieve the object, according to the invention, there is provided an exhaust emission purification catalyst which purifies exhaust gas of an engine, the exhaust emission purification catalyst comprising:

a carrier which is formed with a plurality of cell holes; and

a plurality of catalytic layers which are carried in the plurality of cell holes, the plurality of catalytic layers including:
a first layer including an auxiliary catalyst that includes a zeolite including a transition metal that occludes NOx in the exhaust gas during a time period of low temperature; and
a second layer disposed adjacent to a surface of the first layer and including a main catalyst that includes at least one of an alkali metal and an alkali earth metal and that occludes the NOx occluded in the auxiliary catalyst when temperature of the main catalyst reaches active temperature.

The second layer may further include at least one of rhodium, platinum and palladium.

The transition metal may be iron.

The NOx may be transferred from the auxiliary catalyst to the main catalyst when the temperature of the main catalyst reaches the active temperature.

According to the invention, there is also provided a controller for the engine, the controller comprising:

the exhaust emission purification catalyst according to claim 1, which is provided in an exhaust path; and

a controlling unit, configured to control the engine in an operating mode, the operating mode including a low temperature operating mode in which when warming up the main catalyst during the period of low temperature, an air-fuel ratio is set so that the air-fuel ratio is made leaner than a stoichiometric air-fuel ratio and an amount of fuel which enables to increase the temperature of the main catalyst is supplied.

The operating mode may include a transfer mode in which the air-fuel ratio is set so that the air-fuel ratio is made leaner than the stoichiometric air-fuel ration at a temperature at which the NOx occluded in the auxiliary catalyst is desorbed therefrom, and the NOx is transferred from the auxiliary catalyst to the main catalyst.

The operating mode may include a reduction operating mode in which an amount of NOx to be occluded in a NOx occluding agent in the main catalyst is estimated, and when the estimated amount of NOx reaches a preset amount, a reducing agent is introduced into the main catalyst so that the NOx is reduced from the main catalyst.

### BRIEF DESCRIPTION OF THE DRAWINGS

FIG. 1 is a sectional view showing a part of an exhaust emission purification catalyst according to an embodiment of the present invention.

FIG. 2 is a block diagram showing an engine and its exhaust system according to the embodiment of the invention.

FIGS. 3A and 3B show flowcharts describing control of the engine which includes the exhaust emission purification catalyst and function of the exhaust emission purification catalyst.

FIG. 4 is a graph explaining the function of the exhaust emission purification catalyst.

### DETAILED DESCRIPTION OF EMBODIMENTS

Hereinafter, an embodiment of the invention will be described based on the drawings.

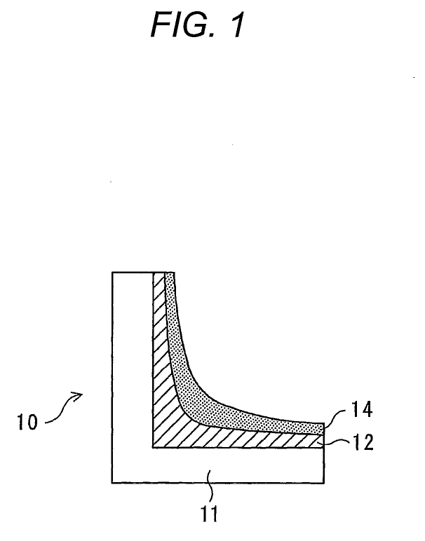

FIGS. 1 to 4 are drawings showing an exhaust emission purification catalyst according to an embodiment of the present invention.

### (Engine and Exhaust System Thereof)

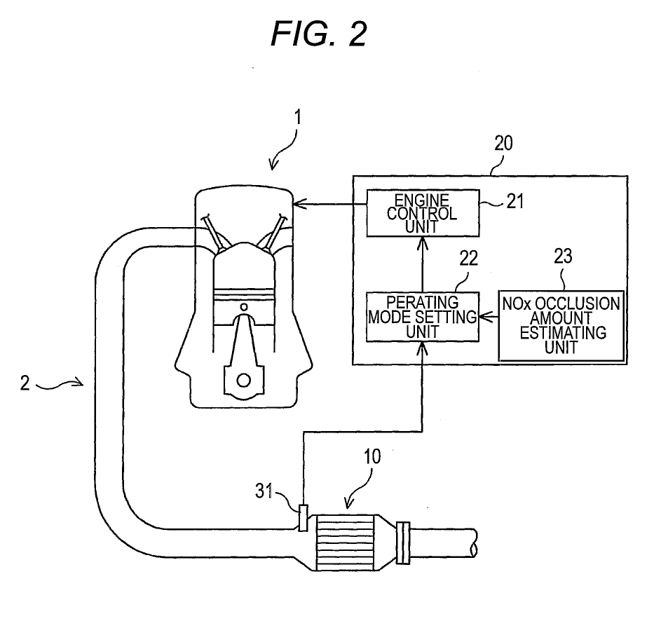

Firstly, an engine which includes an exhaust emission purification catalyst (an exhaust emission control apparatus) according to an embodiment of the invention and an exhaust system of the engine will be described. As is shown in FIG. 2, the engine is a vehicle engine which is installed in a motor vehicle and includes an engine main body 1 having combustion chambers and an exhaust path 2 for discharging exhaust gases generated as a result of combustion in the engine main body 1, with the exhaust emission purification catalyst (the exhaust emission control apparatus) 10 of the embodiment installed in a position along the length of the exhaust path 2.

In addition, the engine is a gasoline engine and includes a controller 20 for controlling fuel injection amount, intake air amount, ignition timing and the like. Additionally, as running or operating modes of this engine, there are provided a stoichiometric operating mode in which the engine feedback operates so that the air-fuel ratio is held in the vicinity of a stoichiometric air-fuel ration and a lean operating mode in which the air-fuel ratio is made leaner (thinner) than the stoichiometric air-fuel ratio so that the engine open loop operates with excessive oxygen.

Because of this, the controller 20 includes an engine control unit 21 for controlling fuel injection amount, intake air amount, ignition timing and the like, and an operating mode setting unit 22 for selecting, based on engine operating conditions such as engine speeds and engine loads (for example, an accelerator opening or a parameter based on the accelerator opening), the stoichiometric operating mode when an engine output demand becomes equal to or larger than a reference level, and for selecting the lean operating mode when the engine output demand becomes less than the reference level. The engine control unit 21 controls fuel injection amount, intake air amount, ignition timing and the like based on the engine's operating condition and the operating mode of the engine that is selected by the operating mode setting unit 22.

In addition, when the engine idles during a time period of low temperatures that takes place before a main catalyst reaches its active temperature (in a cold phase), the operating mode setting unit 22 is made to select the lean operating mode, and the engine control unit 21 is made to supply an amount of fuel which enables a required increase in temperature of the main catalyst so as to increase the heat of combustion of fuel in the engine (to thereby increase the engine speed, as well) and to retard the ignition timing so as to promote the warming up of the main catalyst. In addition, whether or not the catalyst is in the cold phase can be determined from information on what is detected by a temperature sensor 31 for detecting the temperature of the catalyst in such a manner that in the event that a catalyst temperature Tc is a reference value TcO, the catalyst is determined to be in the cold phase.

Further, the controller 20 includes a NOx occlusion amount estimating unit 23 for estimating an amount of NOx occluded by a related-art method to avoid a reduction in NOx occluding performance which results when the amount of NOx occluded by a NOx occluding agent, which will be described later, is increased. In addition, when the NOx occlusion amount estimated by this NOx occlusion amount estimating unit 23 reaches a predetermined value which is preset, a reducing agent is introduced into the NOx occluding agent so that NOx is reduced and desorbed from the NOx occluding agent, whereby the NOx occluding performance is recovered. Thus, the reducing mode is included as one of the operating modes of the engine, and the operating mode setting unit 22 is made to set the reducing mode based on information from the NOx occlusion amount estimating unit 23. In addition, here, fuel is introduced as a reducing agent in this reducing mode. Namely, by the air-fuel ratio being made rich, CO, HC and H2 are caused to be generated so as to function as the reducing agent.

### (Exhaust Emission Purification Catalyst)

An exhaust emission purification catalyst 10 includes a carrier mounted in an interior of a catalyst casing, and the carrier has a large number of cell holes as to have a honeycomb structure. The carrier includes therein an auxiliary catalyst for purifying exhaust gases when the engine 1 and the catalyst 10 are in the cold phase, and the main catalyst for purifying exhaust gases after the cold phase.

FIG. 1 is an enlarged sectional view of the cell hole in the carrier 11. The carrier 11 is made of, for example, cordierite or stainless steel, and the carrier 11 includes an inner layer 12 having a function as the auxiliary catalyst and an outer layer 14 having a function as the main catalyst which are disposed in a laminar fashion thereon sequentially in that order. Namely, the inner layer (also, referred to as a bottom layer or a lower layer) 12 is disposed on surfaces of the cell holes in the carrier 11, and the outer layer (also, referred to as a top layer of an upper layer) 14 is disposed on the surface of the inner layer 12.

The inner layer 12 is disposed in such a manner as to be adjacent to the surfaces of the cell holes and includes the auxiliary catalyst which contains as its main constituent a zeolite which contains a transition metal element. Here, the auxiliary catalyst contains as its main constituent a zeolite which contains iron (Fe) as the transition metal element. Hereinafter, a catalyst made up of the zeolite which contains iron will be referred to as an iron zeolite catalyst.

In general, the zeolite has a composition expressed by xM₂/nO.Al₂O₃.ySiO₂.zH₂O (where, n denotes a valence of a positive ion, x a number falling in a range of 0.8 to 1.2, y a number of 2 or larger, and z a number of 0 or larger). In the case of the iron zeolite catalyst, however, an iron element is ion exchanged for an aluminum element in the zeolite. In addition, the zeolite which contains the transition metal element is a zeolite in which a transition metal element is ion exchanged for an aluminum element in the zeolite.

The zeolite described above which contains the transition metal element has a capability to trap NOx even under a relatively low-temperature condition, and in particular, the zeolite which contains the iron element has a high capability to trap NOx at the relatively low-temperature conditions.

The outer layer 14 contains barium or potassium which is an alkali earth metal and also contains rhodium, platinum and palladium. The outer layer 14 has a function as a NOx occluding agent which occludes NOx in a predetermined active temperature zone.

Namely, by arranging the NOx occluding agent so close as to be brought into contact with the iron zeolite catalyst in the inner layer 12, after trapped NOx is desorbed from the iron zeolite catalyst, the NOx so desorbed is trapped by the NOx occluding agent so as to suppress the discharge thereof into the atmosphere. In addition, since the respective noble metals of rhodium, platinum and palladium have a function of reducing NOx, even in the event that NOx desorbed from the iron zeolite catalyst is not trapped by the NOx reducing agent, NOx not so trapped is reduced to harmless nitrogen. In particular, since rhodium has a high NOx reducing function, by arranging rhodium so as to lie close to the iron zeolite catalyst, rhodium can be made to act on desorbed NOx in an ensured fashion, thereby making it possible to increase the NOx reducing function.

### (Function and Advantage)

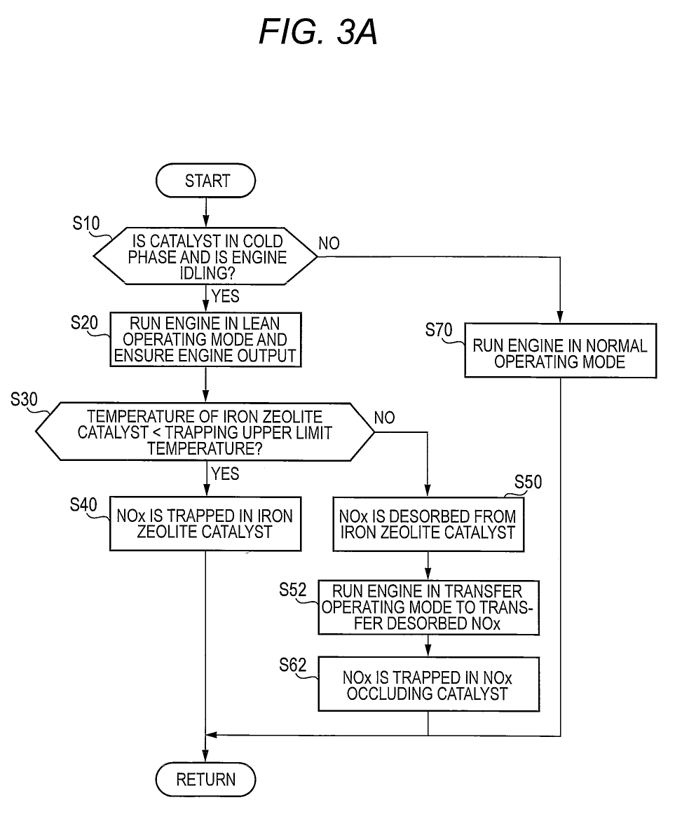

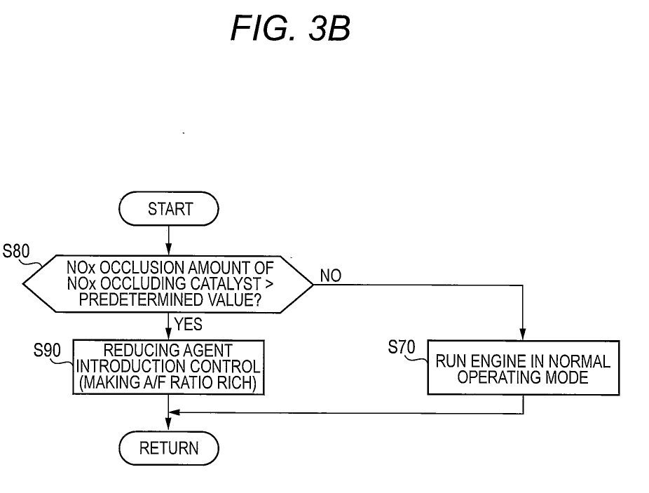

Since the exhaust emission purification catalyst according to the embodiment of the invention is configured as described heretofore, purification of exhaust gases in the cold phase will be implemented as shown in FIGS. 3A and 3B.

Firstly, as is shown in FIG. 3A, it is determined whether or not the catalyst is in the cold phase and the engine is in the idling state (step S10). Whether or not the catalyst in the cold phase can be determined based on the catalyst temperature or the like, and whether or not the engine is idling can be determined based on the accelerator opening or the like.

Here, if it is determined that the catalyst is in the cold phase and the engine is idling, the engine operating mode is set to the lean operating mode, and an amount of fuel which enables an increase in temperature of the main catalyst is supplied (to ensure the output of the engine), whereby the heat of combustion of fuel in the engine is increased (to thereby increase the engine speed, as well) (step S20, low-temperature operating mode). In addition to this, the ignition timing is retarded so as to promote the warming up of the main catalyst.

The generation of HC which tend to be produced in the cold phase can be suppressed by the engine being caused to operate in the lean operating mode. The heat of combustion of fuel in the engine can be increased by increasing the engine speed while ensuring the engine output to some extent and retarding the ignition timing, so as to promote the warming up of the main catalyst, thereby making it possible to shorten the time period of the cold phase.

Although the engine control in the way described above is effective in suppressing the release of HC, generation of NOx in exhaust gases is increased largely. However, since the iron zeolite catalyst traps NOx (step S40) when the catalyst is at low temperatures which are equal to or lower than a trapping upper limit temperature (normally, approximately 100° C.) (a YES route in step S30), the release of NOx into the atmosphere is suppressed.

In addition, when the temperature of the iron zeolite is increased (a NO route in step S30), although NOx is desorbed from the iron zeolite catalyst (step S50), by controlling the engine in the lean operating mode as a desorbed NOx transfer mode (a transfer mode) (step S52), the desorbed NOx is trapped by the NOx occluding agent on the outer layer 14 which lies adjacent to the front surface side of the inner layer 12 which contains the iron zeolite catalyst. Therefore, the release of desorbed NOx into the atmosphere is also suppressed. In addition, since rhodium, platinum and palladium which make up the three-way catalyst are also contained in the outer layer 14, NOx which could not be trapped by the NOx occluding agent is reduced by these noble metals (in particular, rhodium) so as to be formed into harmless nitrogen. In this respect, too, the release of desorbed NOx into the atmosphere is suppressed.

Then, after the cold phase, the normal operating mode, that is, an operating mode which matches the engine operating state is selected (step S70), and purification of exhaust gases produced by the engine is implemented by the main catalyst, that is, rhodium, platinum and palladium in the outer layer 14.

On the other hand, since the NOx occluding performance of the main catalyst is reduced when the amount of NOx occluded by the NOx occluding agent is increased, as is shown in FIG. 3B, a NOx occlusion amount which is estimated by a related-art method is compared with a predetermined value which is preset (step S80). If it is determined that the NOx occlusion amount has reached the predetermined value, a control for introducing a reducing agent into the main catalyst is carried out for a predetermined time period (here, by the air-fuel (A/F) ratio being made rich, CO, BC, H₂ are made to be used as the reducing agent) (step S90, a reduction operating mode). Note that the engine may be made to operate in a stoichiometric fashion as the control of introducing the reducing agent into the main catalyst. In the event that the NOx occlusion amount does not reach the predetermined value or that the control of introducing the reducing agent into the main catalyst is completed, the normal operating mode, that is, an operating mode which matches the engine operating state is selected (step S70).

By the reducing mode being carried out in the way described above, the NOx occluding performance of the NOx occluding agent is recovered, so as to execute the NOx occlusion in the improved fashion, thereby the release of NOx into the atmosphere being suppressed.

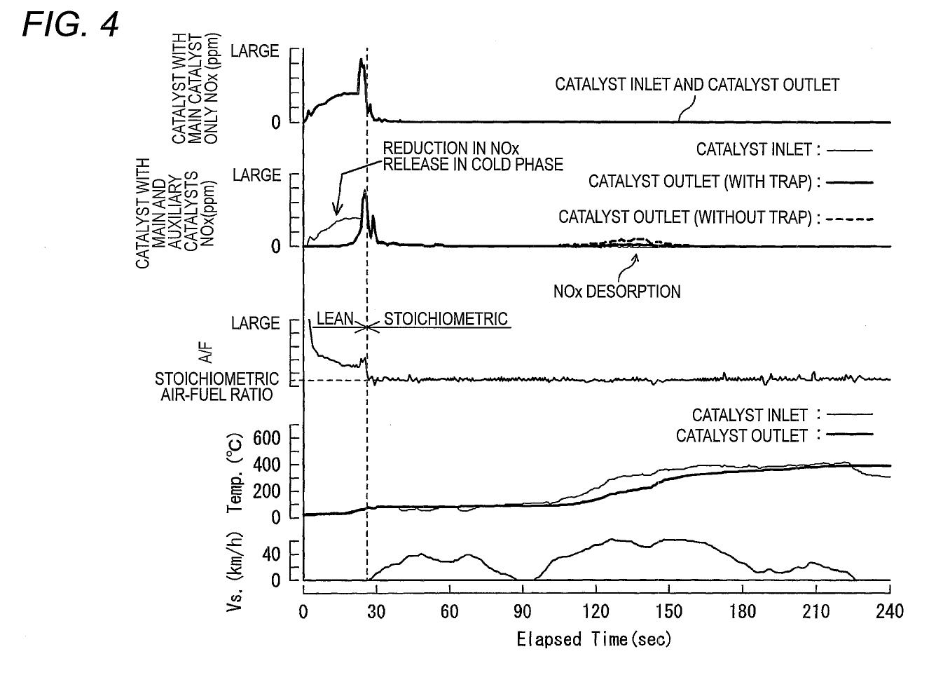

FIG. 4 is a graph showing amount of NOx produced from a catalyst which includes only a main catalyst and amount of NOx produced from a catalyst like the one according to the invention in which an inner layer 12 which contains an auxiliary catalyst (an iron zeolite catalyst) is disposed on an outer layer 13 which contains a main catalyst, together with air-fuel (A/F) ratio and catalyst temperature, when a vehicle which includes an engine is driven in accordance with a predetermined driving mode (with a set vehicle speed Vs) after the engine has been started in the cold state.

The vehicle stands still with the engine idling until approximately 30 seconds elapsed after the engine has been stated in the cold state, and thereafter, the vehicle is accelerated to a predetermined speed range and is then decelerated to stop. Then, the vehicle is accelerated again and is then decelerated in a repeated fashion, this cycle being repeated. When the engine is idling after the engine has been started in the cold state, that is, in such a state that the catalyst is in the cold phase and the engine is idling, the engine operating mode is set to the lean operating mode, and an amount of fuel which enabled an increase in temperature of the main catalyst is supplied, and the ignition timing is retarded so as to promote the warming up of the main catalyst while suppressing the generation of HC.

In the cold phase, as is shown with the catalyst being provided with only the main catalyst, a large amount of NOx is produced and the NOx so produced is discharged into the atmosphere as they were. However, with the catalyst including the auxiliary catalyst (the iron zeolite catalyst) which is added to the main catalyst as in the invention, NOx is reduced largely at a catalyst outlet when compared with a catalyst inlet, and hence, it is seen from this that NOx is trapped by the iron zeolite catalyst so that the amount of NOx released to the atmosphere is reduced largely.

In addition, thereafter, when the vehicle is started by the operating mode of the engine being switched from the lean operating mode to the stoichiometric operating mode, the catalyst temperature is increased gradually, and the NOx trapped by the iron zeolite catalyst starts to be desorbed therefrom. Therefore, in the event that the NOx occluding agent is kept refrained from trapping NOx, although the amount of NOx at the catalyst inlet is reduced, the amount of NOx at the catalyst outlet is increased as indicated by a broken line in FIG. 4. However, with the catalyst of the embodiment of the invention, since NOx desorbed from the iron zeolite catalyst is trapped by the NOx occluding agent, an increase in the amount of NOx at the catalyst outlet is suppressed as is indicated by a thick solid line in FIG. 4.

Thus, in the present invention, the release of HC and NOx into the atmosphere can be reduced largely without using the HC trapping catalyst in the way described above.

Thus, while the embodiment of the invention has been described, the invention is not limited to the embodiment but can be modified as required without departing from the spirit and scope thereof.

For example, in the embodiment, while the zeolite containing the iron element which has the high NOx trapping capability even at low temperatures is illustrated as being the zeolite which contains the transition metal, as the transition metal that is contained in the zeolite, other transition metals such as copper, chromium, manganese, cobalt, nickel and zinc can be used.

In addition, the NOx occluding agent (the NOx occluding catalyst) in the outer layer 14 only has to contain at least either of an alkali metal and an alkali earth metal.

In addition, while the embodiment is described as the invention being applied, in particular, to the gasoline engine, the invention can be applied to a diesel engine which employs a NOx occluding catalyst.

According to an aspect of the invention, NOx in exhaust gases produced during the time period of low temperatures which takes places before the main catalyst reaches its active temperature (in the cold phase) is trapped by the zeolite containing the element of transition metal contained in the inner layer of the plurality of catalyst layers and the release of NOx is then suppressed. Thereafter, after the main catalyst has reached its light-off temperature, NOx is released from the zeolite, and NOx so released is then occluded by the NOx occluding agent contained in the main catalyst, that is, at least either of an alkali metal and an alkali earth metal which functions to occlude NOx that is occluded in the auxiliary catalyst. Consequently, the release of NOx produced in the cold phase into the atmosphere can be reduced largely.

Additionally, since the zeolite containing the element of transition metal is disposed in the inner layer and the outer layer is disposed on the surface of the inner layer, the zeolite in the inner layer is freed from a direct contact with a flow of exhaust gases, whereby there is provided an advantage that a fear of NOx once trapped in the zeolite being diffused and released by the flow of exhaust gases is reduced.

In addition, as in the engine controller, in the cold phase, by setting the air-fuel ratio so that it becomes leaner than the stoichiometric air-fuel ratio and supplying the amount of fuel which enables the required increase in temperature of the main catalyst for warming up the catalyst, the temperature of the catalyst can be increased while suppressing the generation of HC by running the engine in the lean operating mode so as to shorten the time period of cold phase. Although this approach is effective in suppressing the discharge of HC, the generation of NOx in the exhaust gases is increased largely. However, by adopting the exhaust emission purification catalyst of the invention, the release of NOx into the atmosphere can be reduced largely, whereby the release of HC and NOx into the atmosphere in the cold phase can be reduced largely without using the HC trapping catalyst.

Additionally, by setting the air-fuel ratio so that it becomes leaner than the stoichiometric air-fuel ratio at the temperature at which NOx is released from the zeolite included in the inner layer for transfer of NOx from the auxiliary catalyst to the main catalyst, the release of NOx into the atmosphere can be reduced largely even when the engine is being run in the lean operating mode.

In addition, although the NOx occluding performance is reduced when the amount of NOx occluded in the NOx occluding agent is increased, by causing the reducing agent to be introduced into the main catalyst so as to reduce NOx when the estimated NOx occlusion amount has reached the amount preset, the NOx occluding performance can be recovered.

In addition, by causing the outer layer to contain at least any of rhodium, platinum and palladium which function as catalysts in addition to at least either of the alkali metal and the alkali earth metal which occlude NOx, the NOx occluding function and the NOx purifying function can be incorporated integrally into the exhaust emission purification catalyst, whereby the exhaust emission control apparatus can be configured compact. Additionally, even in the event that NOx desorbed from the zeolite is not occluded in the NOx occluding agent, NOx can be reduced and purified for release by the reducing action by rhodium, platinum or palladium, thereby making it possible to promote the reduction in the amount of NOx released into the atmosphere. In particular, by rhodium contained in the outer layer, the NOx reduction and purification can be promoted by making use of the high reducing function of rhodium.

Further, by the inner layer being caused to be made up of the catalyst which contains as its main constituent zeolite containing iron, since the zeolite which contains iron traps NOx in the cold phase in an ensured fashion, the release of NOx produced in the cold phase into the atmosphere can be reduced in an ensured fashion.

What is claimed is:

1. An exhaust emission purification catalyst which purifies exhaust gas of an engine, the exhaust emission purification catalyst comprising:
a carrier which is formed with a plurality of cell holes; and
a plurality of catalytic layers which are carried in the plurality of cell holes, the plurality of catalytic layers including:
a first layer including an auxiliary catalyst that includes a zeolite including a transition metal that occludes NOx in the exhaust gas during a time period of low temperature; and
a second layer disposed adjacent to a surface of the first layer and including a main catalyst that includes at least one of an alkali metal and an alkali earth metal and that occludes the NOx occluded in the auxiliary catalyst when temperature of the main catalyst reaches active temperature.

2. The exhaust emission purification catalyst according to claim 1, wherein
the second layer further includes at least one of rhodium, platinum and palladium.

3. The exhaust emission purification catalyst according to claim 1, wherein
the transition metal is iron.

4. The exhaust emission purification catalyst according to claim 1, wherein
the NOx is transferred from the auxiliary catalyst to the main catalyst when the temperature of the main catalyst reaches the active temperature.

5. A controller for the engine, the controller comprising:
the exhaust emission purification catalyst according to claim 1, which is provided in an exhaust path; and
a controlling unit, configured to control the engine in an operating mode, the operating mode including a low temperature operating mode in which when warming up the main catalyst during the period of low temperature, an air-fuel ratio is set so that the air-fuel ratio is made leaner than a stoichiometric air-fuel ratio and an amount of fuel which enables to increase the temperature of the main catalyst is supplied.

6. The controller according to claim 5, wherein
the operating mode includes a transfer mode in which the air-fuel ratio is set so that the air-fuel ratio is made leaner than the stoichiometric air-fuel ration at a temperature at which the NOx occluded in the auxiliary catalyst is desorbed therefrom, and the NOx is transferred from the auxiliary catalyst to the main catalyst.

7. The controller according to claim 5, wherein
the operating mode includes a reduction operating mode in which an amount of NOx to be occluded in a NOx occluding agent in the main catalyst is estimated, and when the estimated amount of NOx reaches a preset amount, a reducing agent is introduced into the main catalyst so that the NOx is reduced from the main catalyst.
